(19) United States
(12) Patent Application Publication
(10) Pub. No.: US 2023/0028761 A1
(43) Pub. Date: Jan. 26, 2023

(54) EXHAUST AND ELECTRICAL GENERATION SYSTEM

(71) Applicant: Alternative Sustainability IP LLC, Fleming Island, FL (US)

(72) Inventor: John A. STEVENS, New York, NY (US)

(73) Assignee: Alternative Sustainability IP LLC, Fleming Island, FL (US)

(21) Appl. No.: 17/812,680

(22) Filed: Jul. 14, 2022

Related U.S. Application Data
(60) Provisional application No. 63/203,282, filed on Jul. 15, 2021.

(51) Int. Cl. F03D 9/25; F03D 9/34

(52) U.S. Cl. CPC F03D 9/25; F03D 9/34; F05B 2220/602; F05B 2220/706; F05B 2220/20

(57) ABSTRACT

An exhaust system for generating electricity is disclosed. The exhaust system for generating electricity uses a specially configured housing, a plurality of static velocity increasing devices, a turbine, and a fan to generate electricity and concurrently exhaust air from a building. In particular, the specially configured housing preferably is designed to be significantly more aerodynamic and reduces any turbulence inside the housing.

### CLAIM OF PRIORITY

This application claims priority to U.S. Provisional Patent Application No. 63/203,282, filed Jul. 15, 2021, entitled “Exhaust and Electrical Generation System”, the contents of which are hereby incorporated by reference in their entirety.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### FIELD OF THE EMBODIMENTS

The present disclosure relates generally to an exhaust system for generating electricity. More particularly, the present disclosure relates to an exhaust system for generating electricity that uses a specially configured housing, a plurality of static velocity increasing devices, a turbine, and a fan to generate electricity.

### BACKGROUND

The United Nations and the International Organization for Migration both estimate that roughly three million people move to cities each week. In 1930 about 30% of the global population lived in cities. Today, that number is almost 55%. Thus, there has been a need like never before to safely construct large buildings for housing and places of commerce. Consequently, heating, ventilation, and air conditioning (“HVAC”) systems have become mainstays in large buildings in cities across the world. Although HVAC systems are necessary to properly clean, filter, and climate-control the air, there is a great deal of wasted energy associated with their use.

In order to offset the wasted energy of modern HVAC systems many buildings have turned to using renewable sources of energy, such as solar, hydroelectric, and wind power. Although the earliest windmills date back to the 9^{th} century where they were used by Persians to grind grain and draw water. Today, the fundamentals behind the basic windmill have been extrapolated to convert the energy of the wind into electricity. Wind power has been praised as being one of the most efficient and sustainable forms of renewable energy. Consequently, the Global Wind Energy Council and Greenpeace International boast that by 2050 25 to 30% of global energy will be harvested via wind power.

Further, this increased interest in renewable energy is directly correlated to the recent attentiveness to sustainability. As the threat of energy crisis and climate change becomes more evident, large segments of the global population have come to terms with the inarguable need to move from fossil fuels to renewable sources of energy. Accordingly, city, state, and federal, governments have taken initiative and passed a myriad of rules and regulations aimed at mitigating the burden on the environment. Specifically, many cities, including New York, have passed building regulations that dictate the manner in which a building may be constructed and/or set energy efficiency requirements. Consequently, there is a need for innovation enabling renewable energy use in urban cities. However, there are a number of distinct hurdles that are encountered when attempting to utilize wind power in urban centers.

A typical onshore wind turbine can range from 300 to 600 feet tall, with blades exceeding 100 feet in length. For most urban, and even suburban cities, a typical onshore wind turbine is physically too large to coexist with the city's buildings and inhabitants. Additionally, in the event that a typical onshore wind turbine could meet the spatial requirements for installation, there are a number of concerns including: unsightly appearance, noise pollution, and potential damages to property or life. Many residents are deterred by the physical appearance and noise created by towering wind turbines. Although such wind turbines may be beneficial to the energy needs of these cities, the “eyesore” nature of these turbines often causes property values to decline.

A common proposal is to move wind turbines offshore. However, there are a number of disadvantages with offshore wind power. First, offshore wind farms are very expensive to build and maintain. Second, there is empirical evidence to support that offshore wind farms kill, maim, and/or otherwise disrupt, many species of migratory birds and marine life. Third, offshore wind turbines are at an increased risk of damage due to storms, hurricanes, and high seas.

Furthermore, such massive wind turbines and wind farms are inadequate in solving one of the primary issues facing urban cities, which is that singular buildings must meet energy guidelines. Therefore, for wind turbines to be more reasonably used in urban cities, wind turbines must be scaled down in size and modified to be compatible with large urban buildings. Additionally, traditional tower-style wind turbines are ineffective in major cities where there are buildings at different heights that disrupt steady wind streams.

The majority of urban buildings have dedicated building HVAC systems, exhausts, or other airways. In fact, most cities have a number of regulations that require a building to supply fresh air throughout the structure. Thus, effectively every metropolitan building contains some form of ventilation system, often times operating constantly, providing an uninterrupted airflow.

Unfortunately, there is a great deal of energy waste associated with such HVAC systems. The Pacific Gas and Electric Company estimates that up to 80% of energy can be recovered from exhaust air. While some energy waste can be mitigated by cleaning filters, unblocking intakes, and changing heating and cooling habits, there is a sizeable amount of intrinsic waste in any HVAC system. Furthermore, the speed of the airflow in some HVAC systems is not high enough to properly harness it for energy.

The invention of the present disclosure solves this problem by providing for a novel exhaust system that concurrently generates electricity. The invention of the present disclosure replaces and improves upon existing exhaust systems by capturing energy from the exhausted air using a turbine. To aid in the generation of electricity from this energy capture, the invention of the present disclosure also provides a plurality of static velocity increasing devices and a specially shaped housing that, along with an exhaust fan, combine to provide a constant flow of high-velocity air through the turbine.

In the present disclosure, where a document, act, or item of knowledge is referred to or discussed, this reference or discussion is not an admission that the document, act, item of knowledge, or any combination thereof that was known at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed. It is contemplated that the claims may encompass one or more of the conventional technical aspects discussed herein.

### SUMMARY OF THE INVENTION

The present disclosure provides for an electrical generation system, including a housing having an upper housing end and a lower housing end, having a longitudinal axis, a latitudinal axis, and a vertical axis, the longitudinal and latitudinal axes defining a cross-section of the housing. In an embodiment, the housing includes three sections, a first section extending from the lower housing end, a second section, extending from the upper housing end, preferably where the vertical axis of the lower housing end and the vertical axis of the upper housing end are perpendicular, and a joint section attached to the first section opposite the lower housing end and attached to the second section opposite the upper housing end. In an embodiment, the first section is curved. In an embodiment, the housing is shaped to approximate the number “7”.

In an embodiment, the electrical generation system includes a turbine having a receiving end, an exhaust, and a rotational means for producing energy.

In an embodiment, the electrical generation system includes a fan situated in line with and behind the turbine, relative to an airflow within the housing.

In an embodiment, the electrical generation system includes a first static velocity increasing device, preferably situated in line with and in front of the turbine and the fan, relative to the airflow within the housing. In an embodiment, the first static velocity increasing device has a first end with a first size and a second end with a second size, preferably where the first end of the first static velocity increasing device faces the turbine, and more preferably where the first size of the first static velocity increasing device is smaller than the second size.

In an embodiment, the electrical generation system includes a second static velocity increasing device, preferably situated in line with and between the turbine and the fan. In an embodiment, the second static velocity increasing device has a first end with a first size and a second end with a second size, preferably where the first end of the second static velocity increasing device faces the turbine, the second end of the second static velocity increasing device faces the fan, and more preferably where the first size of the second static velocity increasing device is smaller than the second size.

In an embodiment, the electrical generation system is configured so that the turbine, the fan, the first static velocity increasing device, and the second static velocity increasing device are situated along the vertical axis of the second section.

In an embodiment, the system includes a set of extendible slide mils, preferably, configured such that the turbine, the second static velocity increasing device, and the fan rest upon and are attached to the set of extendible slide rails, and more preferably configured such that the extendible slide rails may be extended past the upper housing end and outside of the housing so as to move the turbine, the second static velocity increasing device, and the fan outside of the housing when extended.

In an embodiment, the system includes a set of support bars, configured such that when the electrical generation system is placed on a building surface, the electrical generation system at least partially rests upon the support bars and the support bars rest upon the building surface, and more preferably configured so that the support bars at least partially support the weight of the housing and its contents.

In an embodiment, the system includes one or more curved pieces attached to the interior of the housing, preferably at a joint section. It an embodiment, the one or more curved pieces are configured such that the one or more curved pieces, when the system is attached to an air source, divert an airflow within the housing aerodynamically through the housing, preferably through the joint section.

In an embodiment, the system includes an air source to which the lower housing end is attached to.

In an embodiment, the system includes an inverter and a battery, wherein the turbine, the fan, the inverter, and the battery are in electronic communication. In a preferred embodiment, the system includes a maximum power point tracker in electronic communication with the turbine, the inverter, and the battery.

In an embodiment, the electrical generation system includes a fan speed controller.

The present disclosure also provides for an electrical generation system, including a housing having an upper housing end and a lower housing end, having a longitudinal axis, a latitudinal axis, and a vertical axis, the longitudinal and latitudinal axes defining a cross-section of the housing. In an embodiment, the housing includes four sections, a first section beginning from the lower housing end, a second section attached to the first section opposite the lower housing end and preferably inclined towards the first section such that the vertical axes of the first and second sections form an obtuse angle, a third section attached to the second section opposite the first section and preferably inclined towards the second section such that the vertical axes of the second and third sections form an obtuse angle, and the vertical axes of the first and third sections are parallel, and a fourth section, which terminates at the upper housing end, attached to the third section opposite the second section and preferably inclined towards the third section such that the vertical axes of the third and fourth sections are non-parallel, and the vertical axes of the fourth and first sections are non-parallel.

In an embodiment, the system includes a turbine having a receiving end, an exhaust, and a rotational means for producing energy. In an embodiment, the system includes a fan situated in line with the turbine, and when the system is attached to an air source, the fan is situated behind the turbine, relative to an airflow within the housing. In an embodiment, the system includes a first static velocity increasing device, situated in line with the turbine, and when the system is attached to an air source, situated in front of the turbine and the fan, relative to an airflow within the housing, preferably having a first end with a first size and a second end with a second size, where the first end of the first static velocity increasing device faces the turbine, and the first size of the first static velocity increasing device is smaller than the second size. In an embodiment, the system includes a second static velocity increasing device, situated in line with and between the turbine and the fan, preferably having a first end with a first size and a second end with a second size, where the first end of the second static velocity increasing device faces the turbine, the second end of the second static velocity increasing device faces the fan, and the first size of the second static velocity increasing device is smaller than the second size. In an embodiment, the system is configured so that the turbine, the fan, the first static velocity increasing device, and the second static velocity increasing device are situated along the vertical axis of the fourth section.

### BRIEF DESCRIPTION OF THE PREFERRED EMBODIMENTS

In the drawings, like elements are depicted by like reference numerals. The drawings are briefly described as follows.

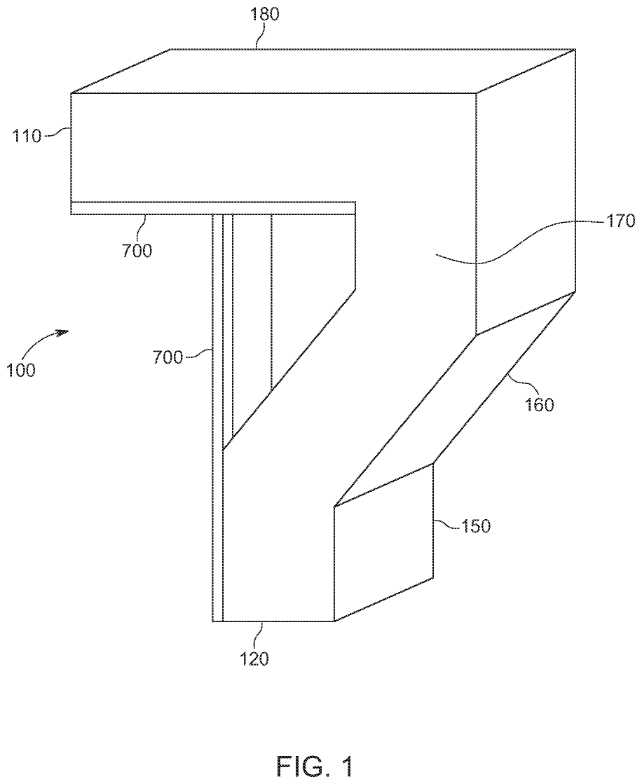

FIG. 1 is a side view, showing an example embodiment of the housing according to the present disclosure.

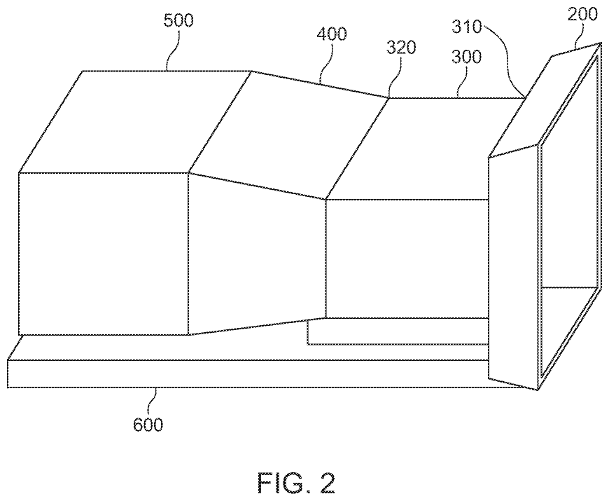

FIG. 2 is a side view, showing an example embodiment of the plurality of static velocity increasing devices, the turbine, and the fan according to the present disclosure.

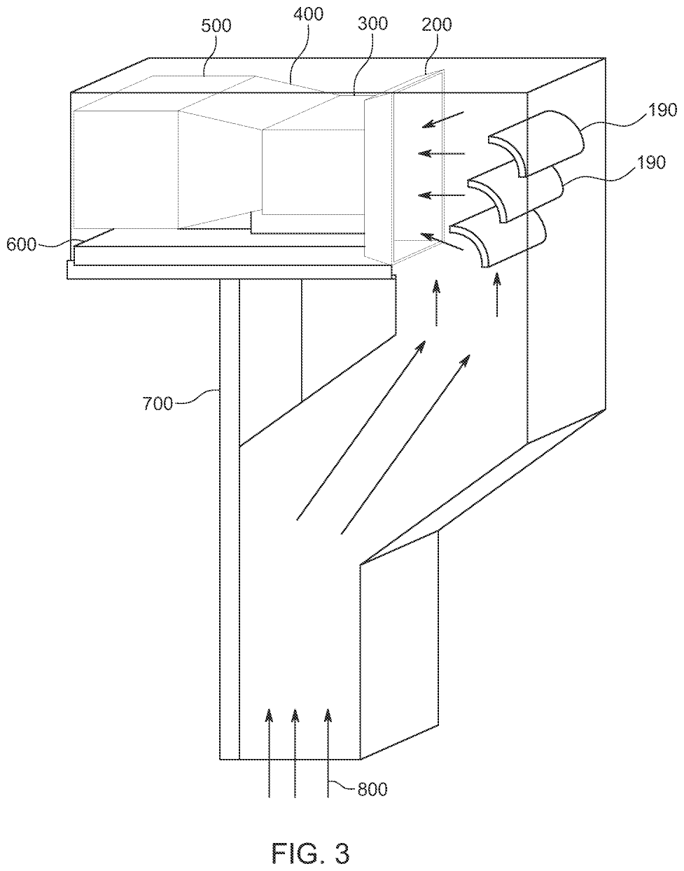

FIG. 3 is a side view, showing an example embodiment of the electrical generation system of the present disclosure.

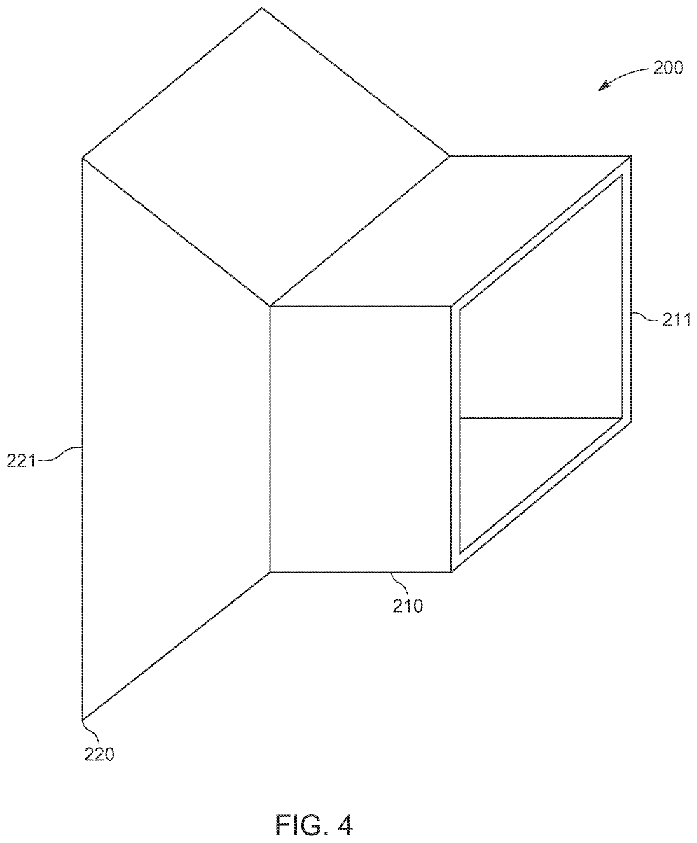

FIG. 4 is a side view, showing an example embodiment of the first static velocity increasing device according to the present disclosure.

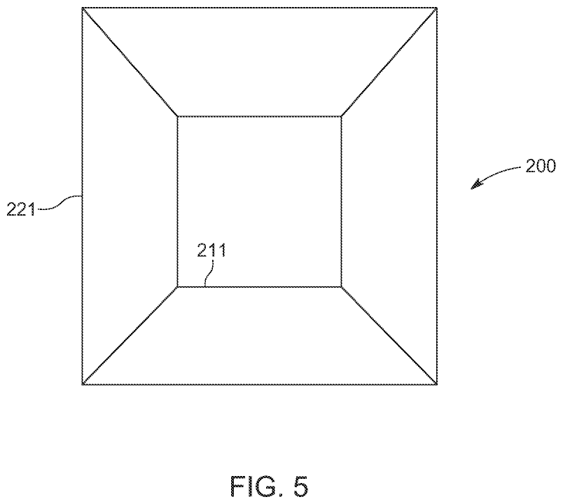

FIG. 5 is a front view, showing an example embodiment of the first static velocity increasing device according to the present disclosure.

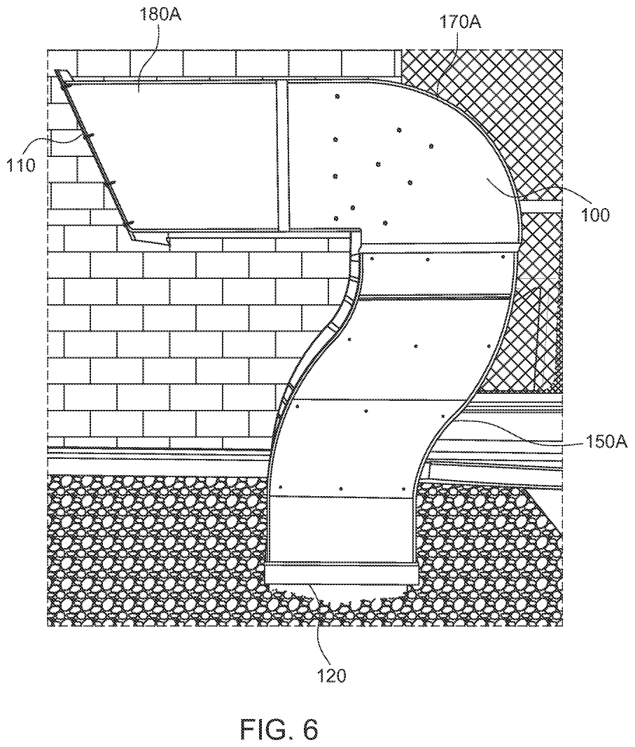

FIG. 6 is a side view, showing an alternate example embodiment of the housing according to the present disclosure.

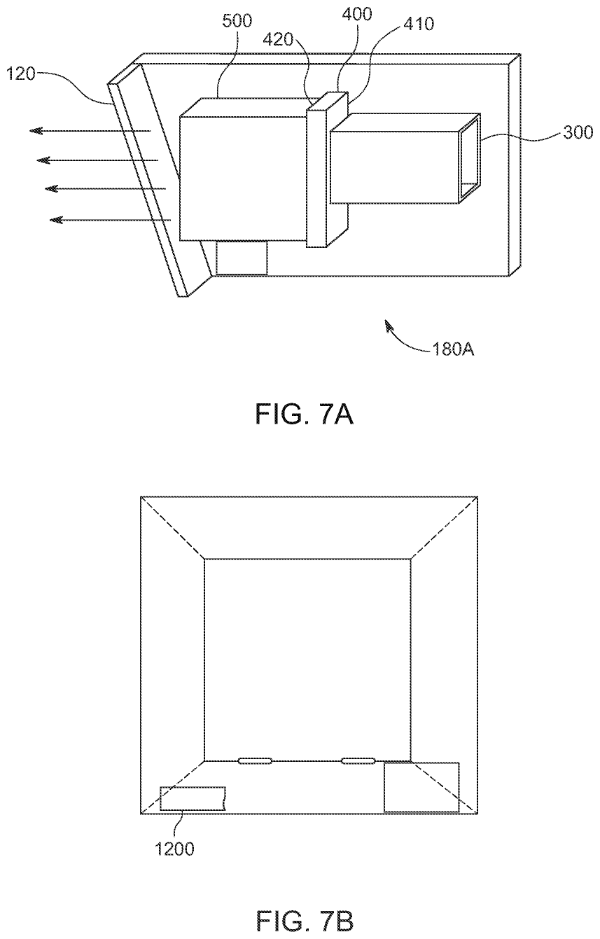

FIG. 7A is a side cross-sectional view of the second section of FIG. 6.

FIG. 7B is a front cross-sectional view of the upper housing end shown in FIG. 7A.

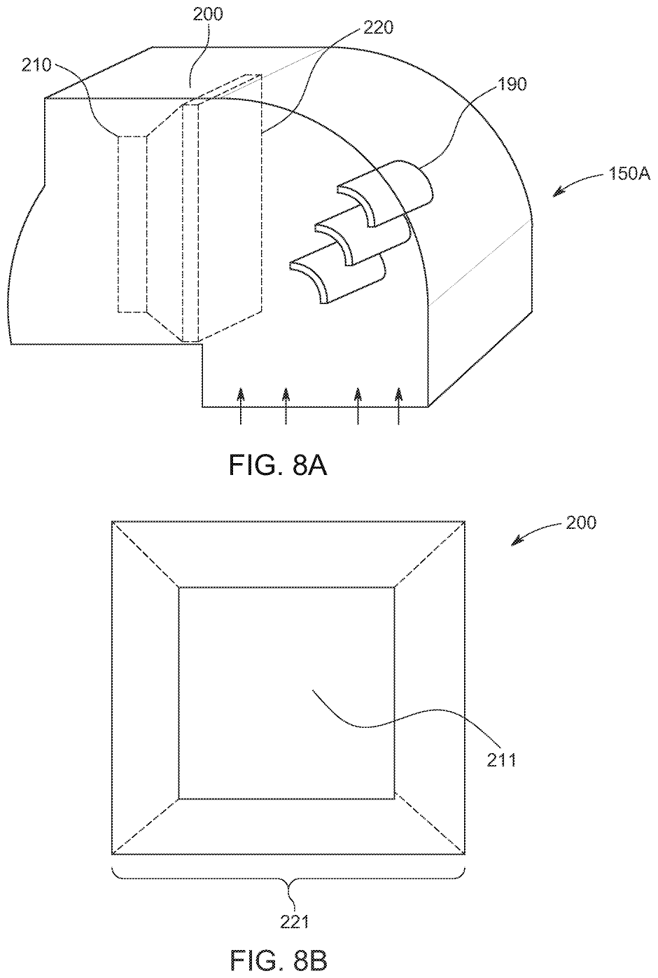

FIG. 8A is a side cross-sectional view of the joint section of FIG. 6.

FIG. 8B is a front cross-sectional view of the first static velocity increasing device depicted in dashed lines in FIG. 8A.

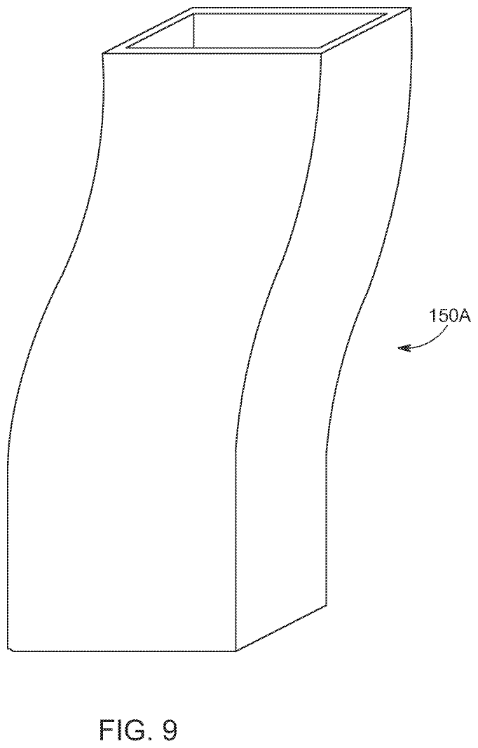

FIG. 9 is a side view of the first section of FIG. 6.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete, and fully conveys the scope of the present disclosure to those skilled in the att. In fact, it will be apparent to those skilled in the art, that various modifications and variations can be made in the present invention without departing from the scope or spirit of the invention.

### DETAILED DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto in any manner whatsoever. In fact, those of ordinary skill in the art may appreciate upon reading the present specification and viewing the present drawings that various modifications and variations can be made thereto.

For purposes of the present disclosure of the invention, unless specifically disclaimed, the singular includes the plural and vice-versa, the words “and” and “or” shall be both conjunctive and disjunctive, the words “any” and “all” shall both mean “any and all”.

An embodiment of the present invention provides a novel housing 100 for exhausting air from a building. With reference to the embodiment illustrated in FIG. 1, the housing 100 has an upper housing end 110, a lower housing end 120, and a plurality of walls, such walls having both an exterior side and an interior side which faces the interior space of the housing. In a preferred embodiment, a cross-section of the housing comprises four walls. In other embodiments, a cross-section of the housing may also be circular, ovoid, rectangular, or any, other shape designed to facilitate airflow along the interior of the housing. A cross-section of an embodiment of the present invention has both a latitudinal and a longitudinal axis. In a preferred embodiment, the lengths of the latitudinal axis and the longitudinal axis are the same. In other embodiments, the lengths of the latitudinal axis and the longitudinal axis are different. In some embodiments, the housing 100 also has a vertical axis which runs along the interior space of the housing 100. In an embodiment, the housing 100 is designed so as to dampen vibrations and noise generated from the interior of the housing. In a preferred embodiment, the interior of the housing is lined with a material that insulates the housing from vibrations and noises generated from the interior of the housing. Such material for dampening vibrations and noises includes, but is not limited to, foams, rubbers, fabrics, fibers, tiles, plastics, composites, and other materials as would be understood by one of ordinary skill in the art as appropriate for this purpose.

In an embodiment, the housing 100 of the present invention is specially shaped so as to increase the velocity of airflow within the housing 100. In an embodiment, the shape of this specially designed novel housing 100 includes at least 3 sections, a first straight section extending directly from the lower housing end, a second inclined section connecting to the first section, and a third section connecting to the second section. In an embodiment, the second section connects to the first section such that the vertical axis of the first section and the vertical axis of the second section form an obtuse angle. In a preferred embodiment, the second section connects to the first section such that the vertical axis of the first section and the vertical axis of the second section form a one hundred and thirty-five degree angle. In an embodiment, the third section connects to the second section such that the vertical axis of the third section and the vertical axis of the second section form an acute angle. In an embodiment, the third section and the first section are aligned so as to not be parallel. In a preferred embodiment, the third section and the first section are aligned so as to be perpendicular. In an embodiment, the sections of the housing combine to approximately form a shape resembling the number seven (7) without serifs.

With reference to the embodiment illustrated in FIG. 1, in a preferred embodiment, this housing includes at least four sections, a first straight section 150 extending directly from the lower housing end 120, a second inclined section 160 connected to the first section 150, a third straight section 170 parallel to the first straight section 150 and connected to the second section 160, and a fourth section 180 connected to the third section 170. In an embodiment, the second section 160 is inclined towards the first section 150 such that the vertical axis of the first section 150 and the vertical axis of the second section 160 form an obtuse angle. In a preferred embodiment, the second section 160 connects to the first section 150 such that the vertical axis of the first section 150 and the vertical axis of the second section 160 form a one hundred and thirty-five degree angle. In an embodiment, the third section 170 connects to the second section 160 such that the vertical axis of the second section 160 and the vertical axis of the third section 170 form an obtuse angle. In a preferred embodiment, the third section 170 connects to the second section 160 at a one hundred and thirty-five degree angle. In a preferred embodiment, the third section 170 is roughly parallel or parallel to the first section 150. In an embodiment, the fourth section 180 and the first section 150 are aligned so as to not be parallel. In a preferred embodiment, the fourth section 180 and the first section 150 are aligned so as to be perpendicular.

With reference to the alternate embodiment illustrated in FIG. 6, in a preferred embodiment, this housing includes at least three sections, a first section 150A extending from the lower housing end 120, which inclines or curves or forms a sinusoid, a second section 180A extending from the upper housing end 110, preferably where a vertical axis of the upper housing end 110 is non-parallel and/or perpendicular to a vertical axis of the lower housing end 120, and a joint section 170A connecting the first section 150A to the second section 180A, preferably in an elbow-like joint, more preferably where such joint is curved.

In various embodiments, the housing 100 comprises a plurality of sections such that the sections combine so that the overall shape of the housing approximates the shape of the number seven (7) without serifs. With reference to FIG. 1, in many embodiments the lowermost section of the housing may be composed of one or more straight duct sections, but in other embodiments, with reference to FIG. 9, the lowermost section of the housing may be composed of one or more curved duct sections. In some embodiments, any section of the housing may be thus composed of straight duct sections, curved duct sections, or some combination thereof. In an embodiment, this novel housing 100 increases the speed of air flowing through the housing by at least 10%, more preferably by 10-15%, and even more preferably by at least 15%. In an embodiment, this novel housing 100 provides less resistance to airflow than the exhaust housing of a conventional downblast fan.

Existing exhaust fans are most commonly updraft or downdraft exhaust fans, sometimes referred to as mushroom fans. These are a very inefficient way to move air, as the air is pulled up into the fan chamber, back down to bottom of the exit area and then back up and out. On average the fan must create 15% more velocity in order to exhaust the through this system and out. Another inefficient aspect of the typical mushroom fan is the motor, pulley, shaft, bearings and belts, as these systems also take extra energy to turn.

In an embodiment, the lower housing end 120 is configured so as to connect to an air source 800. In a preferred embodiment, the lower housing end 120 is configured so as to connect to a vent of a building 800, preferably a rooftop vent. Connection methods include, but are not limited to, fastened by screw, bracket, adhesive, welding, or some other means of fastening.

In a preferred embodiment of the present invention, with reference to the FIG. 3 and FIG. 8A, in particular the curved lines depicted in these figures, the housing also contains curved metal pieces 190, configured to facilitate airflow, particularly aerodynamic airflow, through the interior of the housing. Preferably, the curved metal pieces 190 are disposed at an outer corner of the junction between the final section of the housing and the penultimate section of the housing. These curved metal pieces 190 lessen the sharpness of the angle at this junction and help to facilitate airflow through this junction. In other embodiments, these curved metal pieces 190 may also be found at any place in the housing 100 where the interior sides of the walls join to form an angle, or where the housing 100 itself bends to form an angle.

An embodiment of the present invention also comprises a turbine 300, comprising a receiving end 310, an exhaust 320, a plurality of blades, and a rotor. The plurality of blades may be comprised of a number of blades that, preferably, each extend radially from the rotor, such that the plurality of blades are perpendicular or roughly perpendicular to the fluid flowing through the housing. However, there are alternate embodiments where each of the plurality of blades extend radially and outward from the rotor. In an exemplary embodiment, the turbine is the MicroCube® produced by American Wind, Inc., and as disclosed in U.S. Pat. No. 9,331,534, the entirety of which is hereby incorporated by reference. In some embodiments, the turbine, the fan, and/or either of the static velocity increasing devices may be configured according to the disclosures in U.S. patent application Ser. No. 17/495,536, filed Oct. 6, 2021, the entirety of which is hereby incorporated by reference.

Preferably each of the plurality of blades are spaced equally from each other. In alternative embodiments, either the rotor, the turbine 300, the plurality of blades, or the housing 100, may be angled such that the plurality of blades are facing the incoming fluid at a non-perpendicular angle. In this embodiment, the plurality of blades would not be exactly perpendicular to the incoming fluid. Further, in this embodiment, the angle of the plurality of blades in relation to the incoming fluid may be adjustable.

Further, a mesh screen or other filter may be disposed such that the mesh screen or other filters completely or partially covers the receiving end of the turbine or the opening of the front end of the first static velocity increasing device. Such a mesh screen or other filter may act to obstruct particles or debris that would otherwise damage the turbine. In some embodiments, a removable screen may also cover the upper housing end 110, to obstruct particles or debris from entering the upper housing end 110.

Alternatively, turbine 300 may contain more than one set of a plurality of blades. In such an embodiment, the more than one set of a plurality of blades may be disposed such that one set of a plurality of blades is behind the other. Preferably, in such an embodiment, each plurality of blades would be oriented at the same angle. However, there are further alternate embodiments that may benefit from more than one plurality blades such that each plurality of blades is situated at different angles.

In exemplary embodiments, the turbine 300 further comprises a generator housed within the turbine 300. In this exemplary embodiment, the generator would be initiated by a rotating shaft connected to the plurality of blades. This would cause the generator to produce electricity. However, in other embodiments, the turbine further comprises any rotational means for producing electricity, as known in the field of wind power.

An embodiment of the present invention also comprises a first static velocity increasing device 200 having a first end 210 with a first size 211 and a second end 220 with a second size 221. Preferably, the first static velocity increasing device 200 has a plurality of external sides that interface with an equivalent number of interior sides of the housing 100. In this same embodiment the first static velocity increasing device 200 has a plurality of corresponding internal sides that interface with the air as it passes through the interior space of the housing 100. It is preferable that the internal sides of the first static velocity increasing device 200 are smooth. However, in alternate embodiments the internal sides of the first static velocity increasing device 200 are textured.

Preferably, the first static velocity increasing device 200 is disposed on each of the interior sides of the housing 100. However, there are other embodiments where the first static velocity increasing device 200 is disposed on less than all of the interior sides of the housing 100, preferably opposite sides. The aforementioned embodiments do not act as a means of limiting the number of walls the housing 100 may have. For example, in an embodiment where the housing 100 has six walls, the first static velocity increasing device 200 may be disposed on any number of the interior sides of the six walls.

In a preferable embodiment the first end 210 of the first static velocity increasing device 200 faces the turbine 300 and even more preferably is attached to or is otherwise proximate to the turbine 300, even more preferably facing or proximate to the receiving end of the turbine 310. In an exemplary embodiment, the turbine 300 is seated and/or set within the first static velocity increasing device 200 and past the first end 210 of the first static velocity increasing device 200. In a preferable embodiment, the second end 220 of the first static velocity increasing device 200 faces away from the turbine 300.

In most instances, the first size 211 of the first static velocity increasing device 200 is measured as the diameter of the cross section at the first end 210 of the first static velocity increasing device 200. In those same instances, the second size 221 of the first static velocity increasing device 200 is measured as the diameter of the cross section at the second end 220 of the first static velocity increasing device 200. In an exemplary embodiment the second size 221 of the first static velocity increasing device 200 is larger than the first size 211 of the first static velocity increasing device 200.

In an embodiment, the first static velocity increasing device 200 is shaped like a cone. In an embodiment, the internal sides of the first static velocity increasing device 200 are flat and taper from the second end 220 to the first end 210 linearly. However, in alternative embodiments the internal sides of the first static velocity increasing device 200 are curved. In this alternative embodiment, the internal sides may be curved to resemble an exponential curve, logarithmic curve, or other curve. In further embodiments, with reference to the embodiments illustrated in FIG. 4, FIG. 5, and FIG. 8B, the internal sides of the first static velocity increasing device 200 are composed of two sections, a funnel section, tapering from the second end 220 to the end of the funnel section linearly, and a collar section, with walls that do not taper and instead maintain a consistent cross-section diameter from the beginning of the collar section to the first end 210. In some embodiments, the turbine 300 is seated within the collar section, past the first end 210 of the first static velocity increasing device 200.

In further embodiments, a series of grooves are disposed onto the internal sides of the first static velocity increasing device 200. In such an embodiment, the grooves may be milled into the first static velocity increasing device 200 such that the grooves spiral from the first end 210 to the second end 220. In another embodiment, any number of grooves are milled into the first static velocity increasing device 200 such that the grooves are linear and extend from the first end 210 to the second end 220.

Alternatively, instead of removing material from the first static velocity increasing device 200 like when milling grooves, material may be added to the first static velocity increasing device 200. In such an embodiment material may be added to create the spiraling effect from the first end 210 to the second end 220. Further, material may be added to create linear jetties extending from the first end 210 to the second end 220. In either of these embodiments, the added material may either be easily removable or permanently fixed.

In some embodiments, the first static velocity increasing device 200 is constructed from independent components that have been connected at each of the components ends by a means of fastening well known in the art. Connection methods include, but are not limited to, fastened by screw, bracket, adhesive, welding, or some other means of fastening.

In alternative embodiments, the first static velocity increasing device 200 is manufactured such that the first static velocity increasing device 200 is not originally, independent components. Instead, in this alternative embodiment, the first static velocity increasing device 200 may either be manufactured, pressed, bent, or otherwise configured to be sized to the housing 100.

An embodiment of the present invention, with reference to the embodiment illustrated in FIG. 7B, also comprises a second static velocity increasing device 400, having a first end 410 with a first size 411 and a second end 420 with a second size 421. Preferably, the second static velocity increasing device 400 has a plurality of external sides and a plurality of corresponding internal sides that interface with the sides of the turbine 300. It is preferable that the internal sides of the second static velocity 400 increasing device are smooth. However, in alternate embodiments the internal sides of the second static velocity increasing device 400 are textured.

In a preferable embodiment the first end of the second static velocity increasing device 400 faces the turbine 300 and even more preferably is proximate to the turbine 300, and even more preferably faces or is proximate to the exhaust 320 of the turbine 300. In a preferable embodiment, the turbine 300 is directly connected to the first end 410 of the second static velocity increasing device 400. In an even more preferable embodiment, the first end 410 of the second static velocity increasing device 400 is lined with a material that seals to the turbine 300 and dampens the vibration of the turbine 300. Such material for dampening vibrations and sealing includes, but is not limited to, foams, rubbers, fabrics, fibers, tiles, and other materials as would be understood by one of ordinary skill in the art as appropriate for this purpose.

In a preferable embodiment, the second end 420 of the second static velocity increasing device 400 faces away from the turbine 300. In most instances, the first size 411 of the second static velocity increasing device 400 is measured as the diameter of the cross section at the first end 410 of the second static velocity increasing device 400. In those same instances, the second size 421 of the second static velocity increasing device 400 is measured as the diameter of the cross section at the second end 420 of the second static velocity increasing device 400. In an exemplary embodiment the second size 421 of the second static velocity increasing device 400 is larger than the first size 411 of the second static velocity increasing device 400.

In an embodiment, the second static velocity increasing device 400 is shaped like a cone. In an embodiment, the internal sides of the second static velocity increasing device 400 are flat and taper from the second end 420 to the first end 410 linearly. However, in alternative embodiments the internal sides of the second static velocity increasing device 400 are curved.

In this alternative embodiment, the internal sides may be curved to resemble an exponential curve, logarithmic curve, or other curve. In further embodiments, the internal sides of the second static velocity increasing device 400 are composed of two sections, a funnel section, tapering from the second end 420 to the end of the funnel section linearly, and a collar section, with walls that do not taper and instead maintain a consistent cross-section diameter from the beginning of the collar section to the first end 410. In some embodiments, the turbine 300 is seated within the second static velocity increasing device 400, past the first end 410 of the second static velocity increasing device 400.

In further embodiments, a series of grooves are disposed onto the internal sides of the second static velocity increasing device 400. In such an embodiment, the grooves may be milled into the second static velocity increasing device 400 such that the grooves spiral from the first end 410 to the second end 420. In another embodiment, any number of grooves are milled into the second static velocity increasing device 400 such that the grooves are linear and extend from the first end 410 to the second end 420. Alternatively, instead of removing material from the second static velocity increasing device 400 like when milling grooves, material may be added to the second static velocity increasing device 400. In such an embodiment material may be added to create the spiraling effect from the first end 410 to the second end 420. Further, material may be added to create linear jetties extending from the first end 410 to the second end 420. In either of these embodiments, the added material may either be easily removable or permanently fixed.

In some embodiments, the second static velocity increasing device 400 is constructed from independent components that have been connected at each of the components ends by a means of fastening well known in the art. Connection methods include, but are not limited to, fastened by screw, bracket, adhesive, welding, or some other means of fastening.

In alternative embodiments, the second static velocity increasing device 400 is manufactured such that the second static velocity increasing device 400 is not originally independent components. Instead, in this alternative embodiment, the second static velocity increasing device 400 may either be manufactured, pressed, bent, or otherwise configured to be sized to the housing 100.

The ends of the first 200 and second 400 static velocity increasing devices may be any shape necessary to facilitate connection to the turbine 300 and interface with housing 100 and the other components of the system. These shapes may include circles, squares, rectangles, ovoids, and any other shapes a person of ordinary skill in the art would recognize to be necessary. In an exemplary embodiment, the first end 210 and the second end 220 of the first static velocity increasing device 200 are squares. In an exemplary embodiment, the first end 410 of the second static velocity increasing device 400 is a circle, and the second end 420 of the second velocity increasing device 400 is a square.

In an embodiment of the present invention, the system comprises a fan 500. In an embodiment, the fan 500 is proximate to the second end 420 of the second static velocity increasing device 400. In a preferable embodiment, the fan 500 is directly attached to the second end 420 of the second static velocity increasing device 400. In an embodiment, the second end 420 of the second static velocity increasing device 400 is lined with a material for dampening vibrations and sealing at the connection point between the second end 420 and the fan 500. Such material for dampening vibrations and sealing includes, but is not limited to, foams, rubbers, fabrics, fibers, tiles, and other materials as would be understood by one of ordinary skill in the art as appropriate for this purpose. In an embodiment, the fan 500 spins at 2,000-5,000 rotations per minute (rpm). In an embodiment, the fan 500 spins at 3,000-5,000 rpm. In an embodiment, the fan 500 spins at a speed of greater than 3,000 rpm. In an embodiment, the fan 500 produces 1,000-5,000 cubic feet per minute (cfm) of airflow at a static pressure of between 0-1″ or at a static pressure of less than 2″. In an embodiment, the fan 500 produces 1,500-2,500 cfm of airflow at a static pressure at a static pressure of between 0-1″ or at a static pressure of less than 2″. In an embodiment, the fan 500 produces greater than 1,800 cfm of airflow at a static pressure of between 0-1″ or at a static pressure of less than 2″.

In an embodiment, with reference to the embodiments illustrated in FIG. 2, FIG. 3, FIG. 7A, and FIG. 8A, the first static velocity increasing device 200, the turbine 300, the second velocity increasing device 400, and the fan 500 are all situated along the vertical axis of the final, top, and/or upper section of the housing, relative to the lower housing end 120. In an embodiment, the turbine 300, the second velocity increasing device 400, and the fan 500 are all connected to a set of extendible slide rails 600. Connection methods include, but are not limited to, fastened by screw, bracket, adhesive, welding, or some other means of fastening. In a preferred embodiment, the set of extendible slide rails 600 are capable of extending so that the turbine 300, the second static velocity increasing device 400, and the fan 500 are displaced past the upper housing end 110 and outside of the housing 100.

In an exemplary embodiment, the fan 500 is used in this system to pull the air up, through an angle such as a 90° turn, through the turbine 300 and then exhausted out by a fan, preferably a 12″ axial fan 500. The fan 500 used in the present system contains all the moving parts in one enclosed unit. By using this type of fan 500, there are fewer moving parts than a conventional exhaust system (no pulleys, shafts, bearings or belts which reduces maintenance). This type of fan 500 also uses less energy to turn than a conventional exhaust system. In many embodiments, the system uses a much more aerodynamic duct/housing 100 which brings the air straight up and into a 90° turn, or equivalent angle, that is curved and has inlet guide vanes. This greatly reduces any turbulence inside the duct 100 and keeps the air moving smoothly. The air is pulled by the fan 500 through the duct 100, through the turbine 300 and out.

While the air is pulled through the turbine 300, it spins the turbine blades which spins the generator which creates power.

Depending on the size of the duct 100 and how many CFM need to be exhausted (depends on how many bathrooms or kitchens or other rooms of a building are being exhausted the fan 500 can be set at different speeds to draw more or less CFM out of the building.

The faster the fan speed, the faster the turbine spins and the more energy is created. The slower the fan speed, the less energy is created.

In further preferred embodiments, the housing 100 has at least one set of support bars 700 that attach to a lower edge of the exterior of the final, top, or upper section of the housing 100, relative to the lower housing end 120. In a preferred embodiment, these support bars 700 are configured so as to at least partially support the weight of the housing 100.

In an embodiment, the present invention also comprises a battery, an inverter, and a Maximum Power Point Tracker (“MPPT”). In this embodiment, preferably, power produced by the turbine 300 is electrically transmitted to the MPPT, where the MPPT maximizes and controls current. The MPPT acts as a safeguard so that the battery 300 is not overcharged. Next, in this embodiment, current travels from the MPPT to one or more batteries. In some embodiments there are multiple batteries, in some instances the batteries are configured as a battery bay. Further, in some embodiments the batteries are 12-volt batteries, however, in other embodiments the batteries may be different voltages. In an embodiment, current travels from the one or more batteries to the inverter. The inverter converts the direct current (“DC”) power from the battery into alternating current (“AC”) power. Further, in this embodiment, the fan 500 is connected to the inverter. Thus, in this embodiment, the turbine 300 produces power which may in turn power the fan 500 and other equipment.

In further embodiments, the power generated by the turbine 300 may be stored in the one or more batteries. In alternate embodiments the power generated by the turbine 300 is sent directly to a building's preexisting electrical grid or infrastructure.

In preferred embodiments, the turbine 300 is either attached to or contains a generator with an electrical output cable that is configured to carry electricity. Preferably the electrical output cable is connected to the MPPT or the one or more batteries. However, the electrical output cable may be connected directly to an appliance, other device that is powered by electricity, or directly or indirectly to the electrical grid of the building.

In a preferred embodiment, the turbine 300 further comprises a brake that stops the rotation of the plurality of blades. Such a brake may be invoked when the incoming fluid or air reaches more than 150 miles per hour. However, in other embodiments, the brake may be set to different speed thresholds. In this embodiment, the turbine 300 further comprises a controller that may start the at least one turbine at certain air speeds or initiate the brake at certain speed thresholds.

In other embodiments the turbine 300 further comprises a gear box, a low-speed shaft, and a high-speed shaft. Preferably, the gear box is disposed between a low-speed shaft and high-speed shaft. In preferable embodiments, the gear box contains one or more gears that are configured to increase rotational speed. In this embodiment, the high-speed shaft is further attached to the generator.

In some embodiments, with reference to FIG. 7B, the exhaust and electrical generation system includes a controller 900 configured to control the speed of the fan, preferably where the fan speed controller 900 is disposed beneath the fan.

In an embodiment, the system generates more electricity than is consumed by the fan 500. In an embodiment, the system generates approximately the same amount of electricity as is consumed by the fan 500. In an embodiment, the system generates between 700-900 watts. In an embodiment, the system generates at least 800 watts. In an embodiment, the system generates between 50-300 watts, preferably between 80-270 watts. In some embodiments, the system consumes significantly less net electricity than would be consumed by an equivalent conventional exhaust system. In some embodiments, the system consumes between 100-1,000 watts less than is consumed by an equivalent conventional exhaust system.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” and “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, a “first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the ar to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented an exhaust and electrical generation device. The disclosure is illustrated by example in the drawing figures, and throughout the written description. It should be understood that numerous variations are possible while adhering to the inventive concept. Such variations are contemplated as being a part of the present disclosure.

### Example 1

18 exhaust and electrical generation devices were made according to the present disclosure, particularly according to the embodiments shown in FIG. 6-9. Each housing was a duct having a 16″ by 16″ cross-section. Each housing was shaped as illustrated in FIG. 6 and as a whole measured 60″ tall by 56″ wide when viewed from the side perspective illustrated in FIG. 6.

For each exhaust and electrical generation device, nested in the top section of the housing was an apparatus comprising, at least, in order from furthest away from the upper opening of the housing to the closest, a first static velocity increasing device (a funnel collar), a turbine, a second static velocity increasing device (a funnel cone), and a fan. This apparatus was attached to a set of extending slide rails that allow the entire apparatus to slide out of the upper opening of the housing for easy access for maintenance and other purposes.

The funnel col lar was made with a first end with a first cross-sectional size and a second end with a second cross-sectional size. In addition, the funnel collar was made with two sections, a funnel section and a collar section. The funnel section was made to funnel air toward the turbine and the collar section was made to enclose the front of the turbine so that the turbine is seated within the funnel collar past the first end. The second end was made to face away from the turbine and the second cross-sectional size of such end is larger than the first cross-sectional size of the first end. Here, the second size of the funnel collar was 16″ by 16″ and the first size of the funnel collar was 12″ by 12″.

Each turbine used in each of the exhaust and electrical generation devices was a MicroCube® manufactured by American Wind, Inc. The turbine s square in cross-section to match the first size of the funnel collar, i.e., the turbine has a 9″ by 9″ cross-section.

The turbine was connected to the fan through a funnel cone, with a first end of the funnel cone connected to the turbine and a second end of the funnel cone connected to the fan. The first end of the funnel cone was smaller than the second end, and padded with insulation to fit the turbine. The fan used in this system was a 12″ by 12″ square axial fan.

The 18 exhaust and electrical generation devices so created were installed, between Mar. 27, 2022 to Apr. 25, 2022, on a test building, replacing existing exhaust fans, and run continuously for over 10 weeks. The results, including power consumption comparisons between the exhaust and electrical generation devices and the conventional exhaust fans they replaced, are illustrated in Table 1, below

| | | | | | | | T7 Exhaust Fans | | | | | | | |
|---|---|---|---|---|---|---|---|---|---|---|---|---|---|---|
| | | | | | | Duct | | | | Turbine | Savings | | | |
| | | Existing Exhaust Fans | | | | Static | | | | Watts | | kWh/ | kWh/ | Cost |
| Fan # | CFM | HP | Volts | Amps | Watts | Press | Volts | Ampsts | Watts | produced | Watts | day | Yr | Savings |
| 2 | 420 | 0.25 | 120 | 3.5 | 420 | 0.50 | 120 | 0.71 | 85 | 125 | 335 | 8 | 2,920 | $555 |
| 5 | 600 | 0.17 | 120 | 2.45 | 294 | 0.50 | 120 | 0.71 | 85 | 150 | 209 | 5 | 1,82 | $347 |
| 4 | 600 | 0.17 | 120 | 2.45 | 294 | 0.50 | 120 | 0.71 | 85 | 150 | 209 | 5 | 1,825 | $347 |
| 4A | 1,920 | 0.75 | 208 | 2.65 | 551 | 0.75 | 120 | 2.5 | 300 | 183 | 251 | 6 | 2,190 | $416 |
| | | | | | | | (2) | | | | | | | |
| 5 | 600 | 0.17 | 120 | 2.45 | 294 | 0.50 | 120 | 0.71 | 85 | 150 | 209 | 5 | 1,825 | $347 |
| 5A | 540 | 0.17 | 120 | 2.45 | 294 | 0.50 | 120 | 0.71 | 85 | 95 | 209 | 5 | 1,825 | $347 |
| 6 | 1,200 | 0.75 | 208 | 2.65 | 551 | 0.75 | 120 | 2.5 | 300 | 150 | 251 | 6 | 2,190 | $416 |
| 7 | 1,960 | 0.75 | 208 | 2.65 | 551 | 0.75 | 120 | 1.5 | 180 | 195 | 371 | 8.9 | 3,248 | $617 |
| 7A | 1,320 | 0.50 | 120 | 6.2 | 744 | 0.75 | 120 | 2.5 | 300 | 205 | 444 | 10.7 | 3.905 | $742 |
| 8 | 660 | 0.25 | 120 | 3.5 | 420 | 0.50 | 120 | 0.71 | 85 | 145 | 335 | 8 | 2,920 | $555 |
| 8A | 960 | 0.25 | 120 | 3.5 | 420 | 0.50 | 120 | 2.5 | 300 | 115 | 120 | 2.9 | 1,059 | $402 |
| 9 | 3,840 | 2.00 | 208 | 5.95 | 1,238 | 0.75 | 120 | 2.5 | 300 | 265 | 938 | 22.5 | 8,212 | $1,560 |
| | | | | | | | (2) | | | | | | | |
| 11 | 1,260 | 0.50 | 120 | 6.2 | 744 | 0.75 | 120 | 1.5 | 180 | 140 | 564 | 13.5 | 4,927 | $936 |
| 22 | 1,560 | 2.00 | 120 | 10.1 | 1,212 | 0.75 | 120 | 2.5 | 300 | 195 | 912 | 21.9 | 7,993 | $1,519 |
| | | | | | | | (2) | | | | | | | |
| 1 | 960 | 0.50 | 120 | 6.2 | 744 | 0.50 | 120 | 1.5 | 180 | 128 | 564 | 13.5 | 5,110 | $971 |
| 14 | 960 | 0.50 | 120 | 6.2 | 744 | 0.50 | 120 | 1.5 | 180 | 125 | 564 | 13.5 | 5,110 | $971 |
| Laundry | 600 | 0.75 | 208 | 2.65 | 551 | 1.50 | 120 | 1.5 | 180 | 200 | 371 | 8.9 | 6,022 | $1,144 |
| Totals | | | | | 10,066 | | | | 3,210 | | 6,856 | 164.3 | 63,106 | $11,520 |

What is claimed is:

1. An electrical generation system, comprising:
a housing having an upper housing end and a lower housing end, having a longitudinal axis, a latitudinal axis, and a vertical axis, the longitudinal and latitudinal axes defining a cross-section of the housing, and comprising three sections,
a first section extending from the lower housing end;
a second section, extending from the upper housing end,
wherein the vertical axis of the lower housing end and the vertical axis of the upper housing end are perpendicular; and
a joint section attached to the first section opposite the lower housing end and attached to the second section opposite the upper housing end,
a turbine having a receiving end, an exhaust, and a rotational means for producing energy;
a fan situated in line with and behind the turbine, relative to an airflow within the housing;
a first static velocity increasing device, situated in line with and in front of the turbine and the fan, relative to the airflow within the housing, having a first end with a first size and a second end with a second size,
wherein the first end of the first static velocity increasing device faces the turbine, and the first size of the first static velocity increasing device is smaller than the second size; and
a second static velocity increasing device, situated in line with and between the turbine and the fan, having a first end with a first size and a second end with a second size,
wherein the first end of the second static velocity increasing device faces the turbine, the second end of the second static velocity increasing device faces the fan, and the first size of the second static velocity increasing device is smaller than the second size,
configured so that the turbine, the fan, the first static velocity increasing device, and the second static velocity increasing device are situated along the vertical axis of the second section.

2. The electrical generation system of claim 1, further comprising a set of extendible slide rails attached to the interior of the second section, such that the turbine, the second static velocity increasing device, and the fan rest upon and are attached to the set of extendible slide rails, and such that the extendible slide rails may be extended past the upper housing end and outside of the housing so as to move the turbine, the second static velocity increasing device, and the fan outside of the housing when extended.

3. The electrical generation system of claim 1, further comprising a set of support bars attached to a lower edge of the second section such that when the electrical generation system is placed on a building surface, the second section rests upon the support bars and the support bars rest upon the building surface, and configured so that the support bars at least partially support the weight of the housing and its contents.

4. The electrical generation system of claim 1, further comprising one or more curved pieces attached to the interior of the housing at the joint section, such that the one or more curved pieces, when the system is attached to an air source, are configured to aerodynamically divert an airflow through the joint section.

5. The electrical generation system of claim 1, further comprising an air source to which the lower housing end is attached to.

6. The electrical generation system of claim 1, further comprising an inverter and a battery, wherein the turbine, the fan, the inverter, and the battery are in electronic communication.

7. The electrical generation system of claim 6, further comprising a maximum power point tracker in electronic communication with the turbine, the inverter, and the battery.

8. The electrical generation system of claim 1, further comprising a fan speed controller.

9. The electrical generation system of claim 1, wherein the first section is curved.

10. An electrical generation system, comprising:
a housing having an upper housing end and a lower housing end, having a longitudinal axis, a latitudinal axis, and a vertical axis, the longitudinal and latitudinal axes defining a cross-section of the housing, the housing shaped to approximate the shape of the number “7” without serifs when viewed from the side;
a turbine having a receiving end, an exhaust, and a rotational means for producing energy;
a fan situated in line with and behind the turbine, relative to an airflow within the housing;
a first static velocity increasing device, situated in line with and in front of the turbine and the fan, relative to the airflow within the housing, having a first end with a first size and a second end with a second size,
wherein the first end of the first static velocity increasing device faces the turbine, and the first size of the first static velocity increasing device is smaller than the second size; and
a second static velocity increasing device, situated in line with and between the turbine and the fan, having a first end with a first size and a second end with a second size,
wherein the first end of the second static velocity increasing device faces the turbine, the second end of the second static velocity increasing device faces the fan, and the first size of the second static velocity increasing device is smaller than the second size,
configured so that the turbine, the fan, the first static velocity increasing device, and the second static velocity increasing device are situated horizontally along an interior of the top of the housing.

11. An electrical generation system, comprising:
a housing having an upper housing end and a lower housing end, having a longitudinal axis, a latitudinal axis, and a vertical axis, the longitudinal and latitudinal axes defining a cross-section of the housing, and comprising four sections,
a first section beginning from the lower housing end;
a second section attached to the first section opposite the lower housing end and inclined towards the first section such that the vertical axes of the first and second sections form an obtuse angle;
a third section attached to the second section opposite the first section and inclined towards the second section such that the vertical axes of the second and third sections form an obtuse angle, and the vertical axes of the first and third sections are parallel; and
a fourth section, which terminates at the upper housing end, attached to the third section opposite the second section and inclined towards the third section such that the vertical axes of the third and fourth sections are non-parallel, and the vertical axes of the fourth and first sections are non-parallel;
a turbine having a receiving end, an exhaust, and a rotational means for producing energy;
a fan situated in line with the turbine, and when the system is attached to an air source, the fan is situated behind the turbine, relative to an airflow within the housing;
a first static velocity increasing device, situated in line with the turbine, and when the system is attached to an air source, situated in front of the turbine and the fan, relative to an airflow within the housing, having a first end with a first size and a second end with a second size,
wherein the first end of the first static velocity increasing device faces the turbine, and the first size of the first static velocity increasing device is smaller than the second size; and
a second static velocity increasing device, situated in line with and between the turbine and the fan, having a first end with a first size and a second end with a second size,
wherein the first end of the second static velocity increasing device faces the turbine, the second end of the second static velocity increasing device faces the fan, and the first size of the second static velocity increasing device is smaller than the second size,
configured so that the turbine, the fan, the first static velocity increasing device, and the second static velocity increasing device are situated along the vertical axis of the fourth section.
